(19) United States
(12) Patent Application Publication
(10) Pub. No.: US 2003/0063333 A1
(43) Pub. Date: Apr. 3, 2003

(54) Flatbed scanner with apparatus for scanning light transmissive objects

(76) Inventor: David W. Boll, Greeley, CO (US)

Correspondence Address: HEWLETT-PACKARD COMPANY, Intellectual Property Administration, P.O. Box 272400, Fort Collins, CO, 80527-2400, US

(21) Appl. No.: 09/971,243

(22) Filed: Oct. 3, 2001

(51) Int. Cl. H04N 1/04

(52) U.S. Cl. 358/494; 358/474

(57) ABSTRACT

A flatbed scanner for use with a transmissive object scanning adapter having internal, light reflecting surfaces, comprises a housing; a transparent platen operatively associated with the housing, the platen having a surface for supporting a light transmissive object to be scanned; a movable carriage disposed within the housing, the carriage comprising a light source and a light receiving aperture, a portion of the light source being disposed under the object during scanning; and a light shield mounted on the carriage, the light shield being interposable between the object and the aforementioned portion of the light source.

### BACKGROUND OF THE INVENTION

1. Field of the Invention

The present invention relates generally to optical image scanners and particularly to flatbed scanners fitted with apparatus for scanning light transmissive objects.

2. Description of the Related Art

With reference to prior art FIGS. 1-4, there is shown a conventional reflective flatbed scanner 10 comprising a housing 12 having a longitudinal center line 14, a cover 16 hingedly attached to the housing 12, a transparent platen 18 having a planar, object supporting top surface 20 and a carriage 22 under the platen adapted to be linearly driven along a pair of spaced-apart, parallel longitudinally extending rails 24. The carriage 22 supports a transversely extending light source 26 and defines a transverse light-receiving aperture or slit 28 adjacent to and forward of the light source 26. For simplicity, the scanner control system, carriage drive and other details are not shown, it being understood that these features are also well-known in the art.

During reflective scanning, an object placed on the top surface 20 of the platen 18 is illuminated by the light source 26. Light reflected from the object passes through the light-receiving slit 28 to a photodetector array 30 via a system of mirrors represented in the drawings by a single mirror 32. By way of example, the photodetector array 30 may comprise a charge-coupled device (CCD) for converting the optical image of the object into a digital electronic image.

Adapters for conventional reflective flatbed scanners are available to permit scanning of light-transmissive objects such as slides, negatives, film strips and other transparencies. Generally, such adapters backlight the object from above, the light passing through the light transmissive object, the transparent platen upon which the object has been placed and to the photodetector array via the slit and mirrors.

One type of conventional tranmissive scanning adapter for lower priced scanners provides a source above the platen, usually within the hinged cover of the scanner. Other flatbed scanners featuring transmissive object scanning capabilities incorporate a motorized light source within the hinged cover or as part of a separate, portable unit placed on top of the platen. These adapters, although superior to the area backlight approach in that they concentrate more light through the object and provide a higher quality image, typically require their own electrical power supplies as well as separate motorized light source drives and carriages and thus tend to be complex, expensive and prone to misalignment. Examples of such units are disclosed in U.S. Pat. No. 6,185,011 to William for “FLATBED SCANNER WITH TOP AND BOTTOM LIGHT SOURCES AND A MOVABLE LIGHT SHIELD”; U.S. Pat. No. 6,163,385 to Kajander for “INTEGRATED AND AUXILIARY LIGHT FOR IMAGE SCANNERS FOR SCANNING TRANSPARENCIES AND METHOD OF LIGHTING TRANSPARENCIES FOR IMAGE SCANNING”; U.S. Pat. No. 5,986,774 to Han for “TRANSPARENCY ADAPTER FOR FLATBED SCANNER”; and U.S. Pat. No. 5,652,665 to Chen, et al., for “TRANSPARENCY ADAPTER FOR FLATBED SCANNERS”.

Prior art FIGS. 1-4 show a simplified, low cost, passive adapter 40 that uses the light from the flatbed scanner's own light source and thus does not require a separate light source. Adapters of this kind are available from Hewlett-Packard Company, the assignee of the present invention. An example is Hewlett-Packard's Product No. C7691A, a slide adapter for use with Hewlett-Packard's Models 5300 and 5370 SCANJET® optical scanners.

The adapter 40 is a reflector resembling a pitched roof. Thus, the adapter 40 comprises a pair of identical flat panels 42 and 44 connected along a ridge 46 and set perpendicular to each other. The panels 42 and 44 have interior, light reflective surfaces 48 and 50, respectively. When placed on the top surface 20 of the transparent platen 18, the panels 42 and 44 are each disposed at an angle of 45° to the surface 20, as best seen in FIG. 3. For a scanning operation, the adapter 40 is placed over a light transmissive object 52 with the ridge 46 in alignment with the longitudinal direction of the scanner. The object is positioned under one of the adapter panels, in this case panel 44, to one side of the longitudinally extending ridge 46. Light, represented by a ray 54, directed upwardly from the moving light source 26 is reflected by the interior panel surfaces 48 and 50, down through the light transmissive object 52 and through the slit 28 in the carriage to the photodetector array 30. Although the adapter 40 depicted in FIGS. 1-4 is used for slides, it will be evident that the adapter can be dimensioned to backlight photo negatives in the form of either individual frames or film strips, as well as larger transparencies.

Although the adapter 40 shown in FIGS. 1-4 adequately backlights the transmissive object 52, the quality of the image may be degraded because, as best seen in FIGS. 3 and 4, light (shown as rays 56) from a portion 26a of the light source 26 directly under the object 52 and reflected from the object is incident upon the photodetector array. The combination of light transmitted through the object and light reflected from the object is the cause of image degradation.

### SUMMARY OF THE INVENTION

Accordingly, it is an overall object of the present invention to improve the image quality produced by the type of transmissive object scanning adapter depicted in FIGS. 1-4.

In accordance with a preferred embodiment of the invention, there is provided a flatbed scanner for use with a transmissive object scanning adapter having internal, light reflecting surfaces, in which the flatbed scanner comprises a housing; a transparent platen operatively associated with the housing, the platen having a surface for supporting a light transmissive object to be scanned; a movable carriage disposed within the housing, the carriage comprising a light source and a light receiving aperture, a portion of the light source being disposed under the object during scanning; and a light shield mounted on the carriage, the light shield being interposable between the object and the aforementioned portion of the light source.

In accordance with a specific, preferred embodiment of the invention, there is provided a flatbed scanner for use with a passive, transmissive object scanning adapter having internal, light reflecting surfaces. The scanner comprises a housing, a transparent platen on the housing for supporting an object to be scanned and a movable carriage disposed within the housing. The carriage comprises a light source and a light-receiving aperture, a portion of the light source being disposed directly under the object during scanning. An opaque light shield mounted on the carriage is movable relative to the carriage between a first position and a second position. In the first position of the shield, the shield is retracted and the scanner is operable in a normal, reflective scanning mode in which light from the portion of the light source directed toward the platen is unobstructed. In the second position of the light shield, the shield is extended and the scanner is operable in a transmissive scanning mode in which the shield covers the portion of the light source directly under the object but does not cover the light receiving aperture.

### BRIEF DESCRIPTION OF THE DRAWINGS

The foregoing and other objects, features and advantages of the invention will be evident to those skilled in the art from the detailed description, below, taken together with the accompanying drawings, in which:

FIG. 1 is a perspective view of a conventional flatbed scanner with a light-reflecting adapter placed on the platen of the scanner over a light transmissive object on the platen;

FIG. 2 is a top plan view of the housing of the conventional flatbed scanner shown in FIG. 1;

FIG. 3 is a front elevation view, partly in section, of a portion of the scanner shown in FIGS. 1 and 2 as seen along the line 3-3 in FIG. 2;

FIG. 4 is a side elevation view, partly in section, of a portion of the conventional scanner of FIGS. 1-3 as seen along the line 4-4 in FIG. 3;

FIG. 5 is a top plan view of a flatbed scanner incorporating a light shield in accordance with a specific, exemplary embodiment of the present invention with the light shield shown in its retracted position;

FIG. 6 is a side elevation view, partly in section, of a portion of the flatbed scanner of FIG. 5 as seen along the line 6-6 in FIG. 5;

FIG. 7 is a top plan view of the flatbed scanner shown in FIG. 5 with the light shield in its extended, light-blocking position;

FIG. 8 is a front elevation view, partly in section, of a portion of the flatbed scanner shown in FIGS. 5-7 during a transmissive scanning operation; and

FIG. 9 is a side elevation view, partly in section, of a portion of the flatbed scanner as seen along the line 9-9 in FIG. 8.

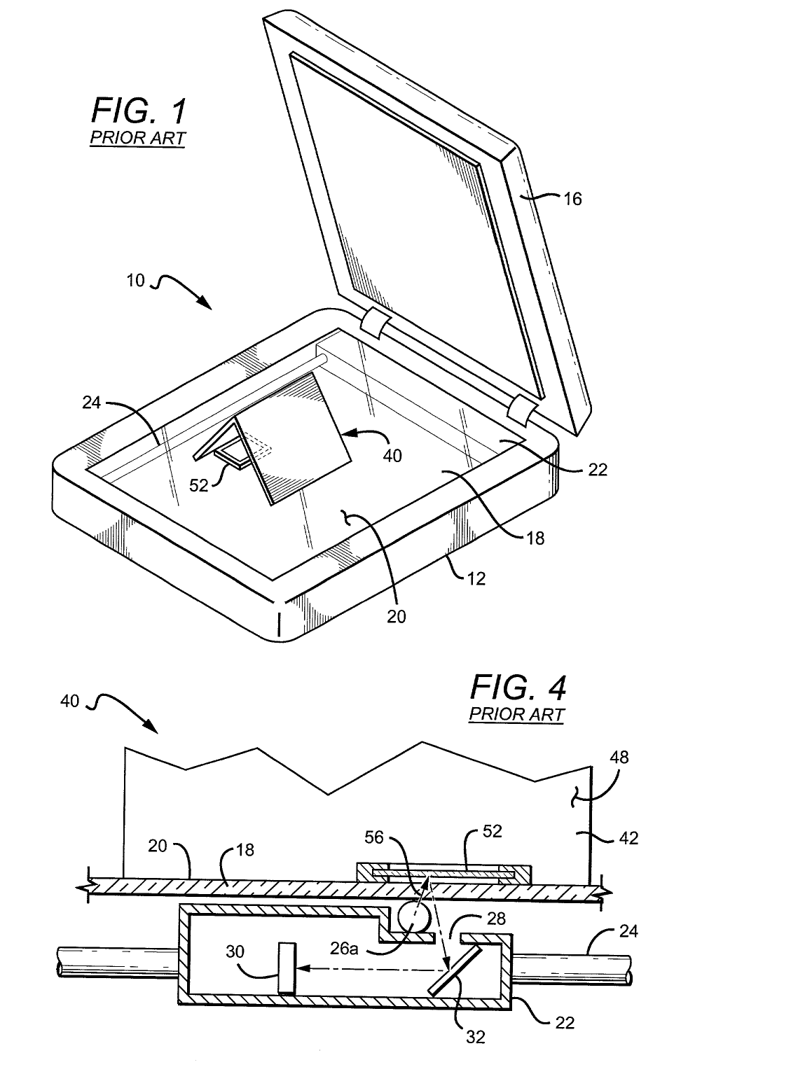

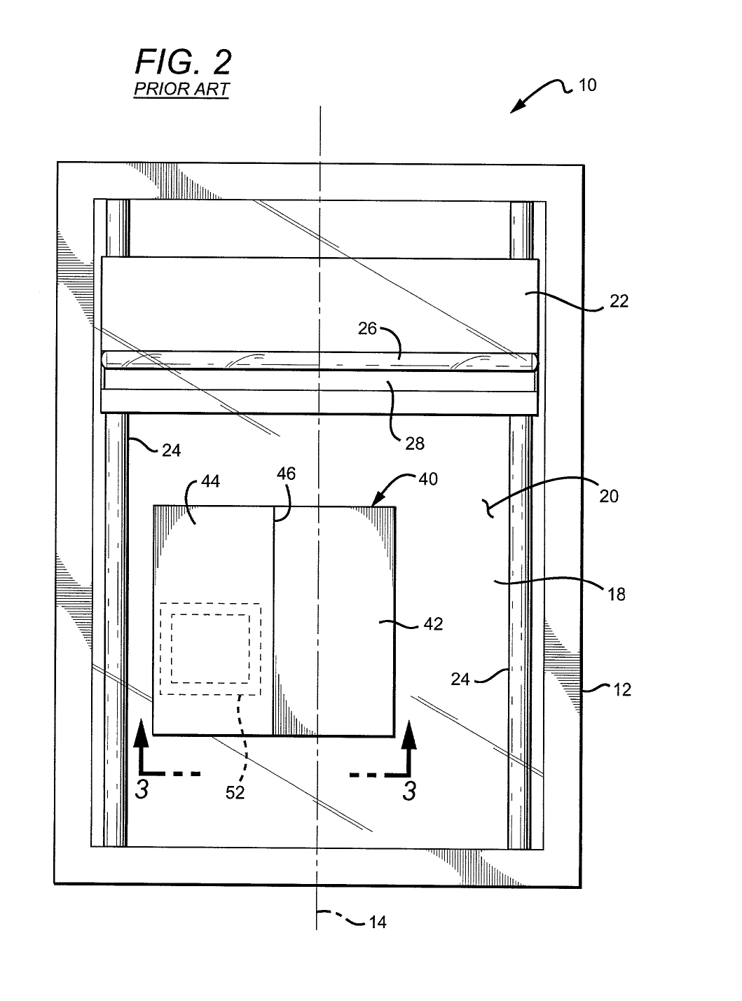

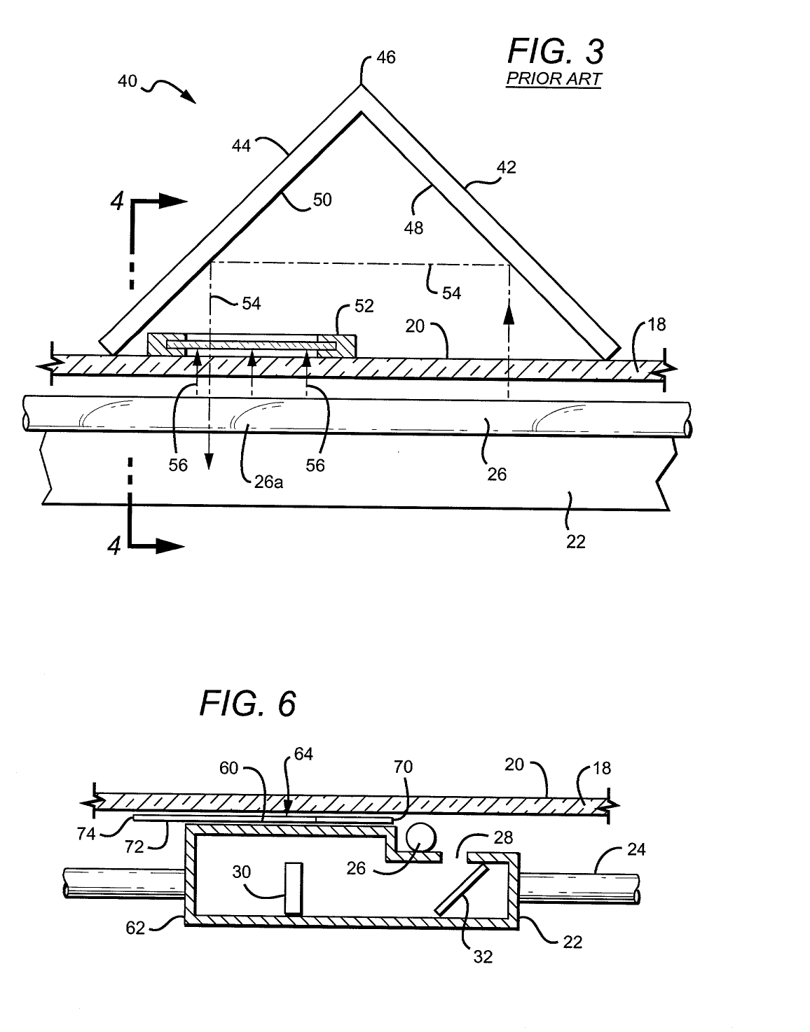

### DETAILED DESCRIPTION OF THE INVENTION

Flatbed scanners equipped with transmissive object scanning capabilities in accordance with the present invention can provide object image quality comparable to that obtained with the motorized light source described earlier at a cost far less than that of the area backlight approach.

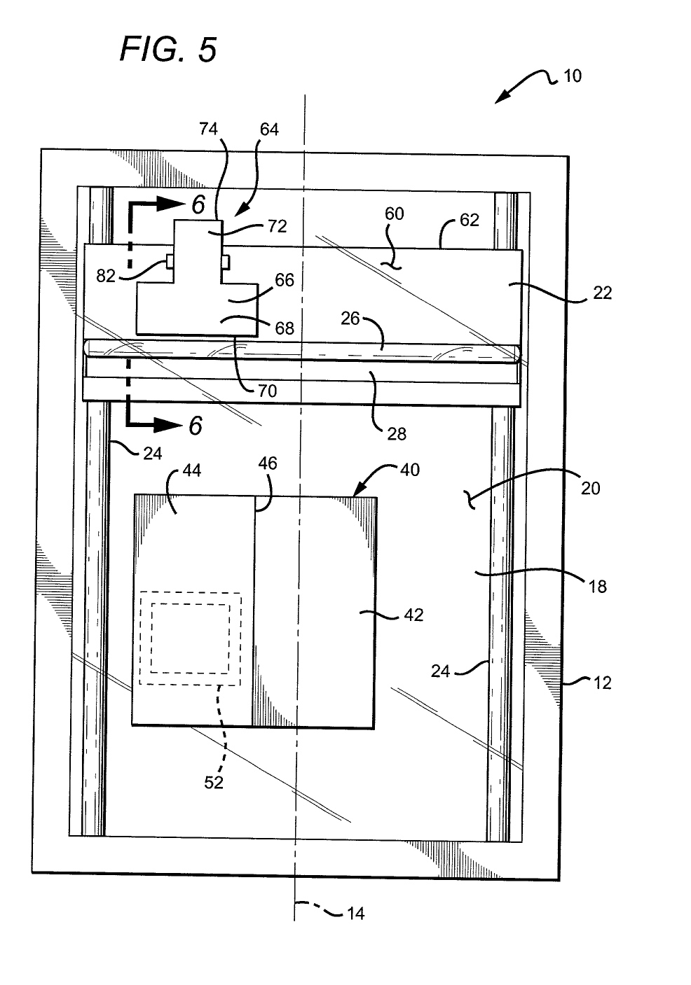

FIGS. 5-9 show the conventional flatbed scanner 10 modified to incorporate features consistent with the teachings of the present invention. The carriage 22 includes a flat, top surface 60 extending between the light source 26 and a transverse rear surface or extremity 62.

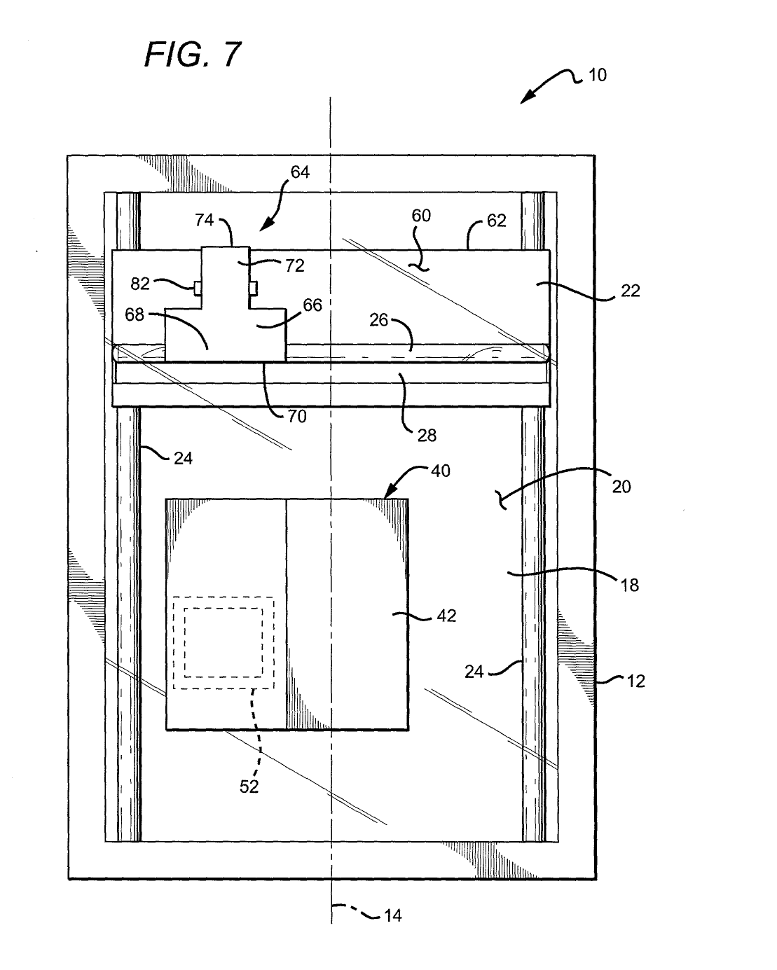

Mounted on the top surface 60 of the carriage is a light shield 64 movable longitudinally relative to the carriage between a first or retracted position shown in FIGS. 5 and 6 and a second or extended position shown in FIGS. 7-9.

In accordance with one specific exemplary form of the invention, the light shield 64 may be fabricated from thin, optically opaque sheet material such as plastic or metal. The specific profile or configuration of the shield will depend on the types of light transmissive objects that are expected to be scanned; by way of example and not limitation, a T-shaped configuration designed for use with photographic slides is shown in the drawings. The specific T-shaped light shield 64 illustrated comprises a main, transverse portion 66 having a front margin 68, a front edge 70 and a rearwardly extending actuator arm 72 having a rear edge 74 disposed, in the first position of the shield (FIGS. 5 and 6), rearwardly of the rear surface 62 of the carriage. The transverse portion 66 of the shield preferably has a longitudinal dimension approximately equal to the longitudinal dimension of the object to be scanned.

With reference to FIGS. 5 and 6, in the first or retracted position of the light shield 64 it will be seen that light from the light source 26 is unobstructed by the shield and in this position of the shield the flatbed scanner 10 may be used in its normal, reflective scanning mode.

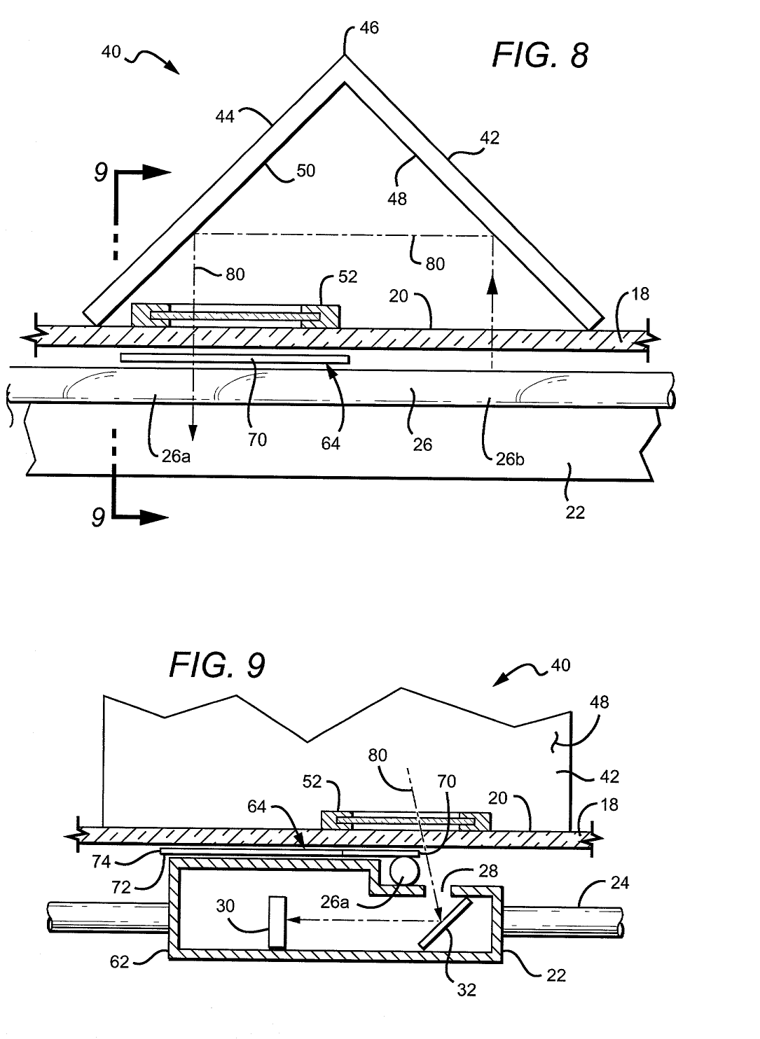

With reference to FIGS. 7-9, in the second or extended position of the light shield 64, the shield has been shifted forwardly relative to the carriage 22 so that the front margin 68 of the shield overlies or covers the portion 26a of the light source 26 so as to obstruct upwardly directed light from that portion of the light source. The rear edge 74 of the actuator arm 72 continues, however, to project at least a small distance rearwardly of the rear surface 62 of the carriage in the second position of the shield. As best seen in FIGS. 7 and 8, the front margin 68 of the shield preferably does not overlie or cover any portion of the light receiving aperture or slit 28 so that light can pass through the slit unobstructed.

Placed on the platen 18 is the conventional reflective adapter 40 described earlier. As before, the adapter 40 covers a light transmissive object 52 to be scanned. In the example shown, the object 52 comprises a slide although it will be evident, as already explained, that any light transmissive object including, for example, a photographic negative, a film strip or a transparency can be scanned within the size limits of the flatbed scanner 10 and an appropriately dimensioned reflective adapter 40. For example, if the light transmissive object to be scanned comprises a film strip a correspondingly elongated adapter would be used.

With reference to FIGS. 8 and 9, with the shield in its second or light obstructing position, light rays (represented by the line 80) from the portion 26b of the light source 26 to the right (as seen in FIG. 9) of the shield 64 is reflected successively from the interior surfaces of the adapter panels 42 and 44, downwardly through the light transmissive object 52, and through the slit 28 to the photodetector array 30. It will be seen that with the shield in the second or extended position, blocking light directed upwardly from the portion of the light source covered by the shield, the object is completely back lit, that is, there is no interfering reflections from the object which would otherwise degrade the image, as already explained.

The shield is preferably mounted for slidable movement in a longitudinal direction relative to the carriage. Such slidable mounting means, shown schematically by blocks 82, may take any convenient form, for example, a pair of plastic guide rails engaging the longitudinal edges of the actuator arm 72. Various expedients for moving the shield between its first and second positions will be evident to skilled artisans. For example, the shield may be translated from its first position to its second position by selecting on the scanner control panel the transmissive scanning mode causing the carriage 22 to initially move past its normal, rearward travel limit causing the rear edge 74 of the shield actuator arm 72 to engage a fixed surface (not shown) inside the housing 12 thereby shifting the shield forward relative to the carriage to its second position. A spring-loaded catch or detente mechanism similar to that employed in ball point pens may be used to retain the shield in the second position. Upon completion of the transmissive scanning operation and selection of the normal reflective scanning mode, the carriage 22 is caused to again travel to its extreme rearward position where the rear edge 74 of the actuator arm 72 again engages the inside surface of the housing 12 or other fixed structure releasing the catch or detente mechanism causing the shield to shift under spring load back to its first or retracted position. Two way, spring loaded catch or detente mechanisms of the kind that may be used herein are well known expedients in the mechanical arts and therefore do not require elaboration.

I claim:

1. A flatbed scanner for use with a transmissive object scanning adapter having internal, light reflecting surfaces, the flatbed scanner comprising:
a housing;
a transparent platen operatively associated with said housing, said platen having a surface for supporting a light transmissive object to be scanned;
a movable carriage disposed within said housing, said carriage comprising a light source and a light receiving aperture, a portion of said light source being disposed under said object during scanning; and
a light shield mounted on the carriage, said light shield being interposable between said object and said portion of said light source.

2. The flatbed scanner defined in claim 1 in which:
said light shield comprises a thin sheet structure mounted on a top surface of said carriage.

3. The flatbed scanner defined in claim 1 in which:
said light shield is movably mounted on said carriage, said light shield being movable between a first position in which said portion of said light source is unobstructed by said light shield and said scanner is operable in a reflective scanning mode, and a second position in which said shield is interposed between said portion of said light source and said object and said scanner is operable in a transmissive scanning mode.

4. The flatbed scanner defined in claim 3 in which:
said shield has an actuating portion adapted to engage a surface on said housing to move the light shield between said first and second positions.

5. A flatbed scanner for use with a passive, transmissive object scanning adapter having internal, light reflecting surfaces, said flatbed scanner comprising:
a housing;
a transparent platen carried by said housing, said platen having a surface for receiving an object to be scanned;
a movable carriage disposed within said housing, said carriage comprising a light source and a light receiving aperture, a portion of said light source being disposed directly under said object during scanning; and
an opaque light shield mounted on said carriage, said light shield being movable relative to said carriage between a first position and a second position, wherein in the first position of said shield, said shield is retracted and said scanner is operable in a reflective scanning mode in which light from said portion of said light source directed toward said platen is unobstructed, and wherein in the second position of said light shield, said shield is extended and said scanner operates in a transmissive scanning mode in which said shield covers said portion of said light source under said object but does not cover said light receiving aperture.

6. The flatbed scanner defined in claim 5 in which:
said light shield comprises a thin sheet movably mounted on a top surface of said carriage.

7. The flatbed scanner defined in claim 5 in which:
said shield has a main portion and an actuating portion, said actuating portion being disposed to engage a surface on said housing to move said light shield from said first position to said second position.

8. The flatbed scanner defined in claim 7 in which:
said actuating portion of said shield is further disposed to engage said surface on said housing to move said light shield from said second position to said first position.
